(19) United States
(12) Patent Application Publication
(10) Pub. No.: US 2015/0370275 A1
(43) Pub. Date: Dec. 24, 2015

(54) DNA OF ENERGY CONSUMING SYSTEMS

(71) Applicant: ENTIC, LLC, PEMBROKE PINES, FL (US)

(72) Inventors: Manuel Rosendo, Pembroke Pines, FL (US); Bin Zheng, Palmetto Bay, FL (US)

(21) Appl. No.: 14/307,489

(22) Filed: Jun. 18, 2014

(51) Int. Cl. G05F 1/66; G05B 15/02

(52) U.S. Cl. CPC G05F 1/66; G05B 15/02

(57) ABSTRACT

A method for virtually connecting design, construction, equipment and control systems as a holistic system to discover the peak performance of energy consuming systems based on system inherent characteristics is provided. The method can include collecting primary information from the energy consuming system, developing energy consuming system schematics, evaluating energy consuming system performance, determining discrepancy and field verification information, defining the energy system limitation for optimization and activating the virtual holistic system and the method further can include performing energy system optimization on the virtual holistic system and performing energy system performance financial analysis on the virtual holistic system.

### BACKGROUND OF THE INVENTION

1. Field of the Invention

The present invention relates to energy consuming systems and more particularly to virtually connect design, construction, equipment and control systems as a holistic system to discover the peak performance of energy consuming systems based on system inherent characteristics.

2. Description of the Related Art

Energy consuming systems are designed by consulting engineers; the product of the mechanical and electrical engineers is the drawings and equipment schedules of the energy consuming system. Convention control systems are designed and installed by control system vendors, and the outputs are control drawings and control systems including hardware and software. The equipment is purchased and installed by general contractors. System engineers conduct the daily operation. Each party has its own design standards and acceptance standards. Most of the time, the standards are in an acceptable range with each user having its own standards. The final energy system performance is a combined result of each party's output.

Traditionally, the process of defining system performance is manual and relies on engineering practices and experience. The manual process involves a comprehensive review of engineering drawings, collecting equipment information, collecting building energy management system information, reviewing control drawings, finding construction flaws, commissioning control systems, and finally optimizing energy systems. Different parties conduct the process, and data is treated independently. Therefore, the system performance is emphasized from different viewpoints and perspectives.

### BRIEF SUMMARY OF THE INVENTION

Embodiments of the present invention address deficiencies of the art in respect to energy consuming systems and provide a novel and non-obvious method, system and computer program product for virtually connecting design, construction, equipment and control systems as a holistic system to discover the peak performance of energy consuming systems based on system inherent characteristics. In an embodiment of the invention, a method for virtually connecting design, construction, equipment and control systems as a holistic system to discover the peak performance of energy consuming systems based on system inherent characteristics is provided. The method can include collecting primary information from the energy consuming system, developing energy consuming system schematics, evaluating energy consuming system performance, determining discrepancy and field verification information, defining the energy system limitation for optimization and activating the virtual holistic system.

In an aspect of the embodiment, the method further can include performing energy system optimization on the virtual holistic system and performing energy system performance financial analysis on the virtual holistic system.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an energy consuming system (e.g., a chiller plant); and;

FIG. 2 is a flow chart illustrating a process for virtually connecting design, construction, equipment and control systems as a holistic system to determine the peak performance of an energy consuming system according to one embodiment of the invention.

### DETAILED DESCRIPTION OF THE INVENTION

Embodiments of the present invention address deficiencies of the art in respect to energy consuming systems and provide a novel and non-obvious method, system and computer program product for virtually connecting design, construction, equipment and control systems as a holistic system to discover the peak performance of energy consuming systems based on system inherent characteristics. In an embodiment of the invention, a method for virtually connecting design, construction, equipment and control systems as a holistic system to discover the peak performance of energy consuming systems based on system inherent characteristics is provided. The method can include collecting primary information from the energy consuming system, developing energy consuming system schematics, evaluating energy consuming system performance, determining discrepancy and field verification information, defining the energy system limitation for optimization and activating the virtual holistic system.

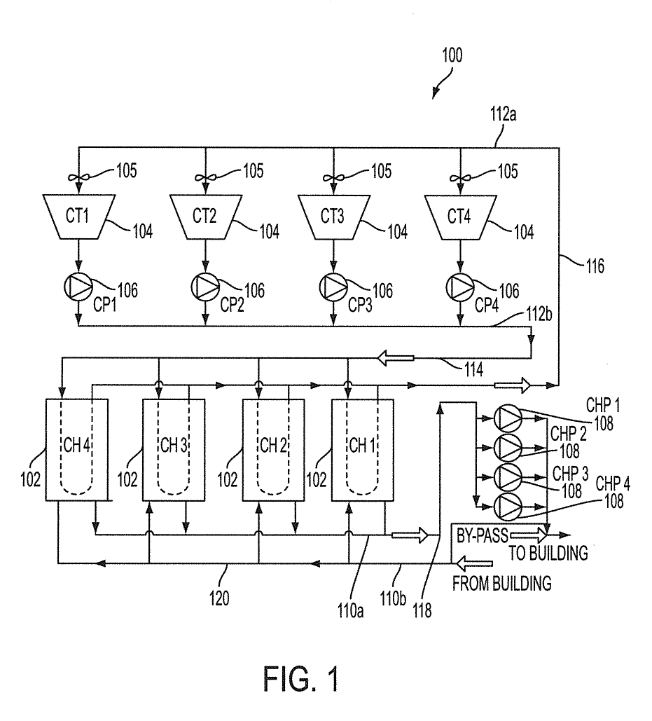

FIG. 1 is a schematic illustration of a chiller plant. The typical chiller plant can be a water cooled system 100 that includes four centrifugal chillers 102 with Variable Flow Devices (VFD) and four cooling towers 104 with variable speed fans 105. The system 100 includes four condenser water pumps 106 and four chilled water pumps 108. The chillers 102, cooling towers 104, four condenser water pumps 106 and chilled water pumps 108 are arranged in parallel and coupled to a common header 110a, 110b on a chilled water side and a common header 112a, 112b on a condenser water side. The heat from the chillers 102 is transferred to condenser water return 112a and then rejected to outside air through the cooling towers 104. The temperature of water through the system at various points is denoted as Condenser Water Supply Temperature (CWST) 114, Condenser Water Return Temperature (CWRT) 116, Evaporator Water Supply Temperature (EWST) 118 and Chilled Water Return Temperature (EWRT) 120 from the building. The amount of heat rejected to the exterior depends on the cooling tower fan speed, the flow rate of water in the cooling towers, outside ambient conditions and building cooling load. An appropriate control scheme is developed to control the system for smooth operation at all times. This control method is commonly predetermined by the Building Management System (BMS).

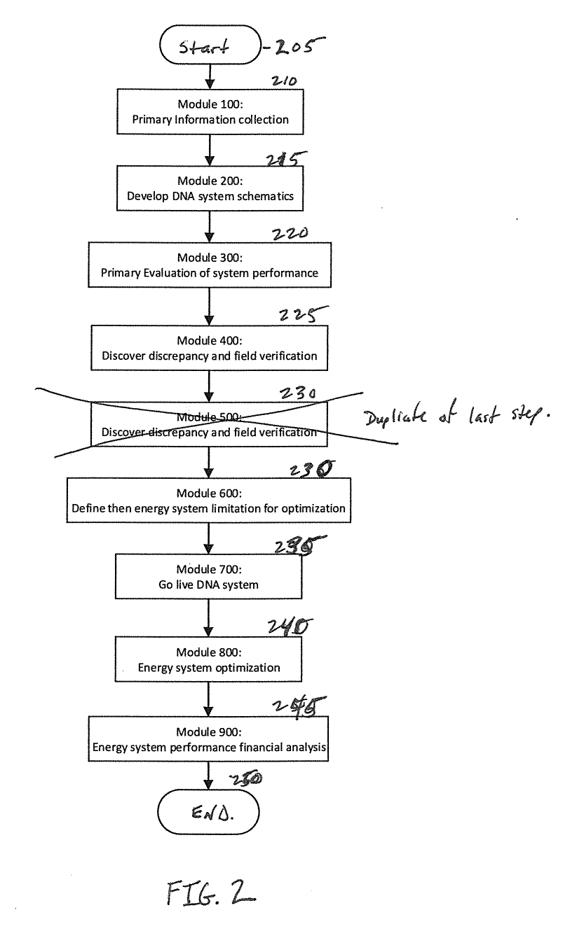

FIG. 2 is a flow chart illustrating a process for virtually connecting design, construction, equipment and control systems as a holistic system to determine the peak performance of an energy consuming system according to one embodiment of the invention. The process for virtually connecting design, construction, equipment and control systems as a holistic system to determine the peak performance of an energy consuming system can commerce in block 205. In block 210, primary information is collected from the energy consuming system. The primary information collection can include collecting system design information, which can include collecting all the performance and tolerances of all the systems that are connected to the entire building, control system information, which are the control sequences that the control system is using to run the equipment, equipment information that includes the performance data from the equipment manufacturers for all mechanical systems, sequences of operation from the BMS, original mechanical design drawings from the building design engineers and system operation information The system operation information is how the building is run 24/7/365 or 12/5/365 basically the run hours. In block 215, energy consuming system schematics can be developed. The schematics can include energy analysis formulae and methods. The energy analysis formulae and methods are any mathematical formulas that are used to calculate energy consumption, define data sources from which the system sensors are available to collect data, provide equipment information such as the size of equipment (HP, tonnage, Delta T of system and display control components such as flow meters, temperature sensors, pressure sensors, IR sensors, Vibration Sensors, kw meters In block 220, the primary system performance can be evaluated The primary evaluation of system performance defines what the Peak Performance of the system is based on the DNA that has been collected. Next, in block 225, discrepancy and field verification information can be determined or measured. In block 230, the energy system limitation for optimization can be defined. The energy system for optimization can include. incorrect equipment that was installed, additions that have been implemented throughout the lifecycle of the building that has negatively effected the original design. In decision block 235, the virtual holistic system can be activated which is the system that is actually installed at the building, which can differ from, was designed. In block 240, the energy consuming system limitation can be defined for optimization so once the actual DNA has been determined we compare that to the way the system is running and find the best optimization for that system. Next, in block 245, energy system performance financial analysis on the virtual holistic system can be performed. Once the Peak performance target is found then we measure the actual and we can tell how much extra the system is costing to run.

In this way, the inventive method brings information collected from different sources together and presents them as facts of the system DNA, which displays the work from different construction phases and the equipment limitation systematically. The inventive method emphasizes on the overall system performance (Peak Performance) not each individual components performance, which maximizes the energy savings. The inventive method reveals the grey areas and mismatches among each parties independent focus. The inventive method evaluates individual component by looking at how it performs as a holistic system. The inventive method also clearly defines responsible parties who need to handle issues. Moreover, the virtual DNA holistic system also provides live information by collecting real time data for users' convenience. Finally, the DNA method is applicable to other energy consuming systems such as chiller plants, air handling systems, lighting systems, elevator systems, water pump stations, oil pump stations, lift stations, solar cell farms and the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for virtually connecting design, construction, equipment and control systems as a holistic system to determine the peak performance of an energy consuming system based on system inherent characteristics, the method comprising:
collecting primary information from the energy consuming system;
developing energy consuming system schematics;
evaluating energy consuming system performance;
determining discrepancy and field verification information;
defining the energy system limitation for optimization; and
activating the virtual holistic system.

2. The method of claim 1, further comprising:
performing energy system optimization on the virtual holistic system.

3. The method of claim 2, further comprising:
performing energy system performance financial analysis on the virtual holistic system.

4. The method of claim 1, wherein the collecting primary information from subsystems of the energy consuming system includes:
collecting system design information;
collecting control system information;
collecting subsystem equipment information;
collecting system operation information; and
verifying system design by inspection and control system sensor readings.
